(19) United States
(12) Patent Application Publication
(10) Pub. No.: US 2025/0376155 A1
(43) Pub. Date: Dec. 11, 2025

(54) METHOD FOR VEHICLE GUIDANCE

(71) Applicant: Robert Bosch GmbH, Stuttgart (DE)

(72) Inventors: Kartik Hanamasagar, Bengaluru (IN); Pratik Kumar Singha, Bengaluru (IN); Stevens Wang, Stuttgart (DE)

(21) Appl. No.: 19/184,247

(22) Filed: Apr. 21, 2025

(30) Foreign Application Priority Data
Apr. 22, 2024 (DE) 10 2024 203 697.8

(51) Int. Cl. B60W 30/06; B60W 40/08; B60W 50/00; B60W 50/14; B60W 60/00

(52) U.S. Cl. CPC B60W 30/06; B60W 40/08; B60W 50/14; B60W 60/001; B60W 2040/0809; B60W 2050/0056; B60W 2420/403; B60W 2420/54; B60W 2554/406; B60W 2554/802

(57) ABSTRACT

A method for vehicle guidance. The method includes: receiving and/or retrieving sensor data, a termination criterion of a vehicle assistance system, and a destination; recognizing and/or tracking a traffic object on the basis of the sensor data, recognizing a driving maneuver of the traffic object on the basis of the tracking of the traffic object; recognizing a traffic jam situation in the vehicle environment using the recognized driving maneuver; and taking over autonomous longitudinal guidance and lateral guidance of the vehicle toward the destination, wherein longitudinal guidance and lateral guidance of the vehicle toward the destination are taken over as long as a termination criterion of the driver assistance system is fulfilled.

### FIELD

The present invention relates to a method for vehicle guidance and a vehicle comprising a control unit for carrying out such a method.

### BACKGROUND INFORMATION

At present, a large number of vehicles are equipped with parking assistance systems that are configured to guide the vehicle autonomously in a specific environment to a parking space or parking area by means of longitudinal and lateral guidance to an end position in this parking space. Here, the parking assistance systems comprise object recognition in the environment. By means of listing the objects and the behavior of the objects in the environment of the vehicle during the parking process, it can be recognized whether vehicles are located in the driving trajectory of the vehicle toward the parking space. If vehicles and/or other objects, such as pedestrians or cyclists, are located in the intended driving trajectory of the vehicle, the parking process is terminated and the system must be reactivated by the driver.

Parking areas are usually located in environments with high traffic volumes. For example, parking spaces at the side of the road are often located in corresponding traffic situations, so that during the vehicle's parking and pulling-out operations, other vehicles may want to pass by the vehicle or pedestrians may cross through the parking space. The same applies to larger parking areas such as shopping centers or parking garages, where a plurality of vehicles can maneuver, park and pull out at the same time, and pedestrians can cross the lanes and driving trajectories.

### SUMMARY

A method for vehicle guidance according to the present invention may have the advantage over the conventional method that premature termination of the parking assistance system is prevented by fulfilling a termination criterion of the driver assistance system. This means that the driver does not have to switch the driver assistance system on again. This results in a much more pleasant driving flow of the vehicle for the driver from a starting position to a destination position in a parking area.

According to an example embodiment of the present invention, the method for vehicle guidance comprises the following steps.

The first step comprises receiving and/or retrieving sensor data, a termination criterion of a vehicle assistance system and a destination.

The second step comprises recognizing and/or tracking traffic objects on the basis of the sensor data. A third step comprises recognizing driving maneuvers of the traffic objects on the basis of the tracking of the traffic objects. A fourth step comprises recognizing a traffic jam situation in the vehicle environment by means of the recognized driving maneuvers. A fifth step comprises autonomous longitudinal guidance and lateral guidance of the vehicle toward the destination. The longitudinal guidance and lateral guidance of the vehicle toward the destination are taken over as long as the termination criterion of the driver assistance system is fulfilled.

Here, a traffic jam situation is understood to mean a traffic situation in which, in addition to the ego vehicle, further traffic objects are located in the traffic trajectory of the ego vehicle toward the destination. In particular, a traffic jam situation is understood to mean a traffic situation in which a further traffic object is trying to pull out of a parking space in which the ego vehicle intends to park. In particular, a traffic jam situation is understood to mean any situation that leads to the termination of a driver assistance system due to the fulfillment of the termination criterion.

In other words, the method for vehicle guidance is designed to recognize whether a driver assistance system is terminated as a result of the fulfillment of termination criteria of the driver assistance system. The method for vehicle guidance intervenes in the longitudinal and lateral guidance of the vehicle on a timely basis in order to prevent the fulfillment of the termination criterion of the driver assistance system. Here, the method for vehicle guidance describes the guidance of the vehicle for the driver assistance system and the longitudinal and lateral guidance is taken over by the method for vehicle guidance as long as the termination criterion of the driver assistance system would otherwise be fulfilled. Thus, such a fulfillment of the termination criterion of the driver assistance system is avoided, and the driver assistance system is not switched off. This results in a smoother driving flow of the vehicle from a current position of the vehicle to a destination.

In particular, the intervention in the longitudinal and lateral guidance of the vehicle in order to prevent the fulfillment of these termination criteria of the driver assistance system can comprise a reduction of the vehicle speed to a standstill and an increase of the vehicle speed again from the standstill of the vehicle.

In particular, the termination criterion comprises the predicted collision duration of the ego vehicle and a further traffic object falling below a predefined collision duration.

Preferred developments of the present invention are disclosed herein.

Preferably, according to an example embodiment of the present invention, the driver assistance system is a parking assistance system and the destination is a target parking position. The termination criterion of the driver assistance system comprises a predefined minimum distance of the vehicle from traffic objects in the vehicle environment. If the predefined minimum distance between the ego vehicle and a further traffic object is not met, the termination criterion is fulfilled. In particular, the termination criterion comprises a predefined minimum distance of the vehicle from traffic objects along the driving trajectory. An advantage of this embodiment can be that the parking process, with its difficult driving maneuvers and the large number of surrounding objects in which the vehicle trajectories can cross, is not interrupted and the parking assistance system does not switch off. Here, a parking assistance system is configured to guide a vehicle autonomously from a current starting position to a target parking position from a specified distance to the target parking position.

Preferably, according to an example embodiment of the present invention, recognizing and tracking traffic objects on the basis of sensor data comprises the following steps. In a sixth step, the sensor data are recorded over a plurality of time steps. In a seventh step, object reflections are recognized in the sensor data. In an eighth step, the object reflections are assigned to one another over a plurality of time steps to form object reflection groups. In a ninth step, object hypotheses are formulated on the basis of the object reflections. In a tenth step, the object reflection groups are assigned to the object hypotheses. An advantage of this embodiment can be that this embodiment makes reliably recognizing and reliably tracking these objects in the environment possible.

Preferably, according to an example embodiment of the present invention, recognizing and tracking traffic objects on the basis of sensor data comprises the following steps. An eleventh step comprises receiving and/or retrieving further sensor data. A twelfth step comprises recognizing further object reflections in the further sensor data and assigning the further reflections to the object hypotheses using a Kalman filter. An advantage of this embodiment can be that by means of this assignment, further sensor data can be reliably assigned to the existing object hypotheses. This improves the reliable tracking of objects over a plurality of time steps.

Preferably, according to an example embodiment of the present invention, recognizing driving maneuvers of traffic objects is carried out on the basis of tracking by means of classifiers and/or artificial intelligence. An advantage of this embodiment can be that reliably recognizing the driving maneuvers of traffic objects in the environment is carried out by means of the use of classifiers and/or artificial intelligence.

Preferably, according to an example embodiment of the present invention, a reduction in the distance between the ego vehicle and a preceding traffic object and/or a following traffic object is recognized as a driving maneuver of the traffic objects. Preferably, a merging of the traffic object into the driving trajectory of the ego vehicle and/or a cutting-out of the traffic object from the driving trajectory of the ego vehicle are recognized as driving maneuvers of a traffic object. Preferably, the driving off of traffic object from a parking area into the driving trajectory of the ego vehicle is recognized as a driving maneuver of the traffic object. An advantage of this embodiment can be that, by means of these recognized driving maneuvers, dangerous situations that would lead to a termination of the driver assistance system can be reliably recognized.

Preferably, according to an example embodiment of the present invention, recognizing the traffic jam situation comprises at least taking into account the distance of a preceding traffic object and/or a following traffic object from the ego vehicle. Preferably, recognizing a traffic jam situation comprises the merging of the traffic object into the driving trajectory of the ego vehicle and/or the cutting-out of the traffic object from the driving trajectory of the ego vehicle. An advantage of this embodiment can be that, taking into account the traffic jam situations listed above, the reliability in avoiding the fulfillment of the termination criterion of the driver assistance system is increased.

Preferably, upon detection of the traffic jam situation, information is output to the driver of the ego vehicle. Preferably, the autonomous longitudinal guidance and/or lateral guidance of the vehicle is only taken over when driver authorization is present. An advantage of this example embodiment of the present invention can be that the behavior of the vehicle is predictable and the driver does not intervene in the longitudinal and lateral guidance of the vehicle.

Furthermore, the present invention comprises a control unit that is configured to perform the method according to one of the above-described embodiments. Thus, the control unit has all the advantages of the corresponding embodiments of the method of the present invention.

Furthermore, the present invention comprises a vehicle having a sensor and the control unit according to the above-described embodiment. The sensor and the control unit are connected to one another for signal exchange. The sensors are configured to detect the vehicle environment. The vehicle thus has all the advantages of the control unit and the method for vehicle guidance of the present invention.

Preferably, the sensors comprise ultrasonic sensors, cameras and/or lidar. An advantage of this embodiment can be that the vehicle's already existing sensors can be used. This reduces the production effort and production costs of the vehicle.

Furthermore, the present invention comprises a computer program that is configured to carry out a method according to one of the above-described embodiments of the present invention.

Furthermore, the present invention comprises a machine-readable storage medium on which a computer program according to the above-described embodiment of the present invention is stored.

### BRIEF DESCRIPTION OF THE DRAWINGS

In the following, exemplary embodiments of the present invention are described in detail with reference to the figures.

FIG. 1 is a schematic representation of a vehicle according to a first exemplary embodiment of the present invention.

FIG. 2 is a schematic representation of a method according to a first exemplary embodiment of the present invention.

FIG. 3 is a schematic representation of the method according to a second exemplary embodiment of the present invention.

### DETAILED DESCRIPTION OF EXAMPLE EMBODIMENTS

Preferably, all the same elements, units and/or assemblies have the same reference signs in all the figures.

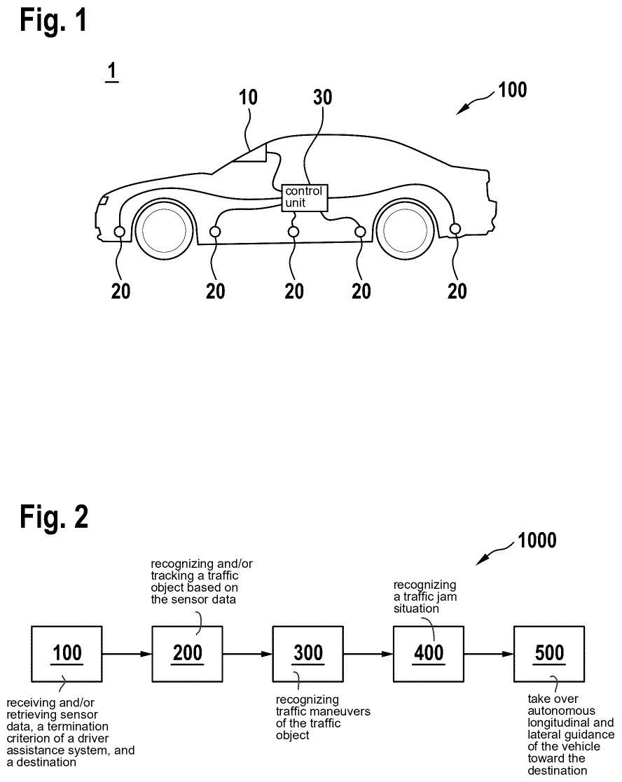

FIG. 1 is a schematic representation of a vehicle 100 according to a first exemplary embodiment of the present invention. The vehicle 100 comprises sensors 10, 20 and a control unit 30. The sensors 10, 20 are connected to the control unit 30 for signal exchange. The sensors 10, 20 are configured to detect a vehicle environment 1. In particular, the sensors 10, 20 comprise a camera 10 and ultrasonic sensors 20. The control unit 30 is configured to perform a method 1000 according to a first exemplary embodiment or according to a second exemplary embodiment.

FIG. 2 is a schematic representation of the method 1000 according to the first exemplary embodiment of the present invention. The method 1000 for vehicle guidance comprises the following steps. A first step 100 comprises receiving and/or retrieving sensor data, a termination criterion of a driver assistance system and a destination. A second step 200 comprises recognizing and/or tracking a traffic object on the basis of the sensor data. A third step 300 comprises recognizing driving maneuvers of the traffic object on the basis of the tracking of the traffic objects. A fourth step 400 comprises recognizing a traffic jam situation in the vehicle environment 1 by means of the recognized driving maneuver of the traffic object. A fifth step 500 comprises taking over the autonomous longitudinal and lateral guidance of the vehicle 100 toward the destination. Here, the longitudinal guidance and lateral guidance of the vehicle 100 toward the destination are taken over as long as the termination criterion of the driver assistance system is fulfilled.

The driver assistance system is a parking assistance system and the destination is a target parking position. The termination criterion of the driver assistance system comprises a predefined minimum distance of the vehicle 100 to the traffic object in the vehicle environment 1. If the distance between the ego vehicle 100 and the traffic object falls below the predefined minimum distance, the termination criterion is fulfilled. The parking assistance system is configured to guide a vehicle 100 autonomously, from a specified distance to a target parking position, from a current vehicle position to the target parking position until a final stopping position is reached. Recognizing the driving maneuver of the traffic object 300 is based on the tracking of the traffic object by means of classifiers.

Furthermore, recognizing driving maneuvers 300 of the traffic object comprises recognizing the reduction of a distance between the ego vehicle and a preceding traffic object and/or a following traffic object. Furthermore, recognizing driving maneuvers 300 of the traffic object comprises recognizing a traffic object cutting out and/or a traffic object merging. Furthermore, a driving off of a traffic object from a parking area into a driving trajectory of the vehicle is recognized as a driving maneuver of the traffic object 300.

Recognizing a traffic jam situation is based at least on taking into account the distance of the preceding traffic object and/or the following traffic object from the ego vehicle. This means that a traffic jam situation is recognized if, during the departure of the preceding or following traffic object, a specified minimum distance to the vehicle is not met. Furthermore, recognizing the traffic jam situation is based on the merging and/or cutting-out of the traffic objects. This means that if a merging of vehicle from another lane and/or from a parking area into the vehicle's own driving trajectory is recognized, a traffic jam situation is recognized. Furthermore, a traffic jam situation is recognized if the cutting-out traffic object cuts out of the current driving trajectory of the ego vehicle into a parking area and/or onto a parallel lane.

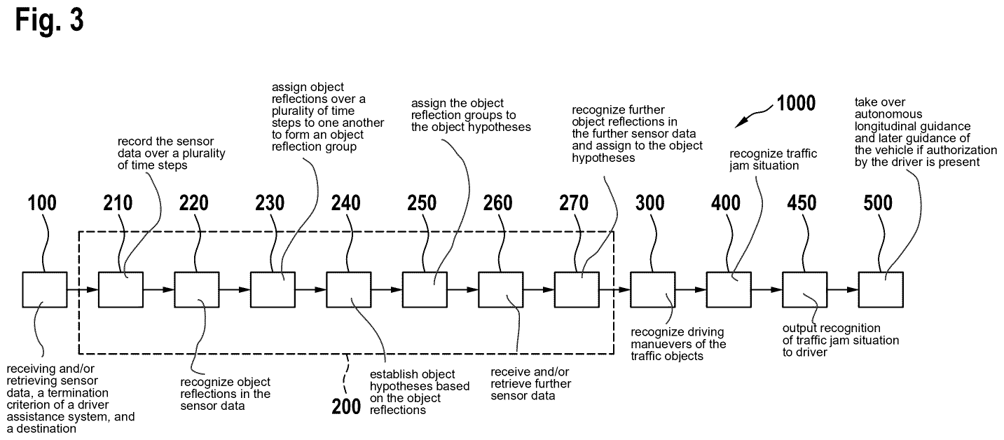

FIG. 3 is a schematic representation of the method 1000 according to the second exemplary embodiment of the present invention. The second exemplary embodiment comprises similar method steps to the first exemplary embodiment.

The method 1000 for vehicle guidance according to the second exemplary embodiment of the present invention comprises the following steps.

The first step 100 comprises receiving and/or retrieving sensor data, the termination criterion of the driver assistance system and the destination. The second step 200 comprises recognizing and/or tracking the traffic object on the basis of the sensor data. The second step comprises the following steps six to twelve. A sixth step 210 comprises recording the sensor data over a plurality of time steps. A seventh step 220 comprises recognizing object reflections in the sensor data. An eighth step 230 comprises assigning the object reflections over a plurality of time steps to one another to form an object reflection group. A ninth step 240 comprises establishing object hypotheses on the basis of the object reflections. A tenth step 250 comprises assigning the object reflection groups to the object hypotheses. An eleventh step 260 comprises receiving and/or retrieving further sensor data. A twelfth step 270 comprises recognizing further object reflections in the further sensor data and assigning the further object reflections to the object hypotheses using a Kalman filter. The third step 300 comprises recognizing driving maneuvers of the traffic objects on the basis of the tracking of the traffic objects. The fourth step 400 comprises recognizing the traffic jam situation in the vehicle environment 1 by means of the recognized driving maneuvers of the traffic objects. A thirteenth step comprises outputting 450 the recognition of a traffic jam situation to the driver. The fifth step 500 comprises taking over the autonomous longitudinal guidance and lateral guidance of the vehicle 100 toward the destination if authorization by the driver is present.

1-12. (canceled)

13. A method for vehicle guidance, comprising the following steps:
receiving and/or retrieving sensor data, a termination criterion of a vehicle assistance system, and a destination;
recognizing and/or tracking a traffic object based on the sensor data;
recognizing a driving maneuver of the traffic object based on the tracking of the traffic object-recognizing a traffic jam situation in an environment of the vehicle using the recognized driving maneuver; and
autonomous longitudinal guidance and lateral guidance of the vehicle toward the destination;
wherein the longitudinal guidance and the lateral guidance of the vehicle toward the destination are taken over as long as the termination criterion of the driver assistance system is fulfilled.

14. The method according to claim 13, wherein the driver assistance system is a parking assistance system and the destination is a target parking position, wherein the termination criterion of the driver assistance system includes a predefined minimum distance of the vehicle from the traffic object in the vehicle environment.

15. The method according to claim 13, wherein the recognizing and tracking of the traffic objects based on the sensor data includes the following steps:
recording the sensor data over a plurality of time steps;
recognizing object reflections in the sensor data;
assigning the object reflections over each of a plurality of time steps to one another to form an object reflection group;
establishing an object hypothesis based on the object reflections; and
assigning the object reflection groups to the object hypothesis.

16. The method according to claim 15, wherein the recognizing and tracking of the traffic objects based on the sensor data includes the following steps:
receiving and/or retrieving further sensor data; and
recognizing further object reflections in the further sensor data and assigning the further object reflections to the object hypothesis using a Kalman filter.

17. The method according to claim 13, wherein the recognizing of the driving maneuver of the traffic object is carried out based on the tracking of the traffic object, using classifiers and/or artificial intelligence.

18. The method according to claim 17, wherein the following driving maneuvers of the traffic objects are recognized:
a reduction of a distance between the vehicle and a preceding traffic object and/or a following traffic object, and/or
a merging of a traffic object of the traffic objects into a driving trajectory of the vehicle and/or a cutting-out of a traffic object from the driving trajectory of the vehicle, and/or
a moving of a traffic object out of a parking area into the driving trajectory of the vehicle.

19. The method according to claim 13, wherein the recognizing of the traffic jam situation is based at least on a distance between the vehicle and a preceding traffic object and/or a following traffic object, and/or a merging of a traffic object into the driving trajectory of the vehicle, and/or a cutting-out of a traffic object from the driving trajectory of the vehicle.

20. The method according to claim 13, wherein the recognition of the traffic jam situation is output to a driver and the autonomous longitudinal guidance and lateral guidance is only taken over when driver authorization is present.

21. A control unit configured for vehicle guidance, the control unit configured to perform the following steps:
receiving and/or retrieving sensor data, a termination criterion of a vehicle assistance system, and a destination;
recognizing and/or tracking a traffic object based on the sensor data;
recognizing a driving maneuver of the traffic object based on the tracking of the traffic object-recognizing a traffic jam situation in an environment of the vehicle using the recognized driving maneuver; and
autonomous longitudinal guidance and lateral guidance of the vehicle toward the destination;
wherein the longitudinal guidance and the lateral guidance of the vehicle toward the destination are taken over as long as the termination criterion of the driver assistance system is fulfilled.

22. A vehicle, comprising:
sensors; and
a control unit configured for vehicle guidance, the control unit configured to perform the following steps:
receiving and/or retrieving sensor data, a termination criterion of a vehicle assistance system, and a destination,
recognizing and/or tracking a traffic object based on the sensor data,
recognizing a driving maneuver of the traffic object based on the tracking of the traffic object-recognizing a traffic jam situation in an environment of the vehicle using the recognized driving maneuver, and
autonomous longitudinal guidance and lateral guidance of the vehicle toward the destination;
wherein the longitudinal guidance and the lateral guidance of the vehicle toward the destination are taken over as long as the termination criterion of the driver assistance system is fulfilled;
wherein the sensors are configured to detect a vehicle environment; and
wherein the sensors are connected to the control unit for signal exchange.

23. A non-transitory machine-readable storage medium on which is stored a computer program for vehicle guidance, the computer program, when executed by a computer, causing the computer to perform the following steps:
receiving and/or retrieving sensor data, a termination criterion of a vehicle assistance system, and a destination;
recognizing and/or tracking a traffic object based on the sensor data;
recognizing a driving maneuver of the traffic object based on the tracking of the traffic object-recognizing a traffic jam situation in an environment of the vehicle using the recognized driving maneuver; and
autonomous longitudinal guidance and lateral guidance of the vehicle toward the destination;
wherein the longitudinal guidance and the lateral guidance of the vehicle toward the destination are taken over as long as the termination criterion of the driver assistance system is fulfilled.
